(19) United States
(12) Patent Application Publication
(10) Pub. No.: US 2008/0242468 A1
(43) Pub. Date: Oct. 2, 2008

(54) Power-Split Transmission

(75) Inventor: Jurgen Wafzig, Eriskirch (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN AG, Friedrichshafen (DE)

(21) Appl. No.: 10/585,957

(22) PCT Filed: Jul. 17, 2004
(86) PCT No.: PCT/EP2004/008027

§ 371 Date: Jul. 13, 2006

(30) Foreign Application Priority Data
Jan. 28, 2004 (DE) 10 2004 004 139.3

(51) Int. Cl. F16H 37/08

(52) U.S. Cl. 475/214

(57) ABSTRACT

A power-split transmission with a variator (1) is proposed, which is constructed as a toroid or friction wheel variator, as a band or chain variator, as a tapered ring transmission or as a continuous hydrostatic transmission, with a variator output transmission (2) including a planetary gearset (9) and a further planetary gearset (3), which, connected before the variator in the direction of the flux of force, serves as a distribution transmission, and, connected behind the variator in the direction of the flux of force, serves as a summation transmission for the power-splits, in which the variator output transmission (2), the variator (1) and the additional planetary gearset (3) are arranged coaxially, and wherein the spatial arrangement of the variator output transmission (2), the variator (1) and the planetary gearset (3) in the output direction are indicated by one of the following schemata; variator (1)—variator output transmission (2)—planetary gearset (3); variator (1)—planetary gearset (3)—variator output transmission (2); planetary gearset (3)—variator (1)—variator output transmission (2); planetary gearset (3)—variator output transmission (2)—variator (1); variator output transmission (2)—planetary gearset (3)—variator (1) and variator output transmission (2)—variator (1)—planetary gearset (3).

This application is a national stage completion of PCT/EP2004/008027 filed Jul. 17, 2004 which claims priority from German Application Ser. No.10 2004 004 139.3 filed Jan. 28, 2004.

### FIELD OF THE INVENTION

The present invention relates to a power-split transmission, which includes a variator.

### BACKGROUND OF THE INVENTION

Transmissions of this type include, for example, continuously adjustable friction wheel variators, which have at least two torus disks with toroid running surfaces between which their rolling elements roll off. Friction wheel variators have a high torque capacity in addition to the continuously variable gear ratio change.

A transmission is known from DE 196 29 213 A1, which can be operated in two performance ranges. The basic components of this known friction wheel drive are a continuously variable friction wheel variator with two toroid running surfaces interacting in pairs, a countershaft as well as a summation transmission. A power-split is provided in the lower region (LOW). The input is conducted by the drive shaft through a gear step to the countershaft and subsequently to the continuously variable transmission (friction wheel variator), which is connected on the output side with the summation transmission. The input is conducted through a second power-split directly into the summation transmission through the countershaft and a gear step, where the power of both power-splits is summated and forwarded to the output shaft.

In the second performance range (HIGH) of this known transmission, the input is guided through a gear step to the countershaft and subsequently to the continuously variable transmission. A further power component is not provided in this case.

A further transmission is known from DE 197 03 544 Al of the Applicant in which a power-split is provided and a continuously variable transmission, especially a transmission with toroid running surfaces (friction wheel drive) interacting in pairs is used. This known transmission also has an intermediate or countershaft to make possible the desired power-split.

A power-split two range transmission of the type mentioned at the beginning is known from EP 1 253 350 A2 in which a gear is shifted to increase the overall effectiveness in overdrive in which no power flows through the variator since the variator, as a rule, has a worse degree of efficiency than form-locking torque or momentum transmitting facilities. Here the transmission includes a reversing toroid variator, a summation transmission containing a planetary gearset and a planetary gearset that serves as reverse transmission, which are arranged one behind the other in this order in the direction of the flux of force.

The present invention is based on the objective of disclosing a transmission schema for a power-split transmission including a variator, which has great flexibility in relation to installation space and a high degree of efficiency.

### SUMMARY OF THE INVENTION

Accordingly, a power-split transmission with a variator, a variator output transmission including a planetary gearset and a further planetary gearset is proposed, wherein the additional planetary gearset is connected in front of the variator in the flux of force direction as a distributing transmission and serves, connected in the direction of the flow of force behind the variator as a summation transmission for the power-splits in which the variator output transmission, the variator and the additional planetary gearset are arranged co-axially, and wherein the spatial arrangement of variator output transmission, variator and planetary gearset in the output direction is indicated by one of the following schemata:
Variator-variator output transmission-planetary gearset;
Variator-planetary gearset-variator output transmission;
Planetary gearset-variator-variator output transmission;
Planetary gearset-variator output transmission-variator;
Variator output transmission-planetary gearset-variator;
Variator output transmission-variator-planetary gearset.

The co-axiality of the transmission components can hereby be guaranteed by the use of the variator output transmission containing a planetary gearset; in this way, no countershaft is necessary to transfer the variator power to the output.

The variator can be constructed as a toroid or friction wheel variator (single or double cavity, that is with one or two torus disk pairs), as a band or chain variator or also as a continuous hydrostatic transmission.

With a double cavity (reversing) toroid variator with two torus disk pairs, the following additional spatial arrangement possibilities becomes apparent, according to the invention:
Disk pair-variator output transmission-disk pair-planetary gearset;
Disk pair-planetary gearset-disk pair-variator output transmission;
Variator output transmission-disk pair-planetary gearset-disk pair; and
Planetary gearset-disk pair-variator output transmission-disk pair.

Within the framework of further variations of a transmission in accordance with the invention in which a countershaft is provided axially parallel and axially staggered in relation to the variator, the power of the variator is conducted to the output of the transmission through the countershaft through at least one spur gear step and/or at least one belt or chain wheel drive, wherein the variator output transmission is omitted. The following spatial arrangement possibilities for the spur gear steps or belt or chain wheel drives, the variator and the planetary gearset hereby emerge in accordance with the invention:
Variator-spur gear step-spur gear step-planetary gearset;
Variator-spur gear step-planetary gearset-spur wheel set; and
Planetary gearset-variator-spur gear step-spur gear step.

With a double cavity (reversing) toroid variator with two torus disk pairs, the following additional spatial arrangement possibilities in accordance with the invention become apparent:
Disk pair-spur gear step-disk pair-spur gear step-planetary gearset;
Planetary gearset-spur gear step-disk pair-spur gear step-disk pair; and
Disk pair-spur gear step-disk pair-planetary gearset-spur gear step.

Preferably the planetary gearsets are constructed as minus planetary gearsets, but plus planetary gearsets can also be used.

In accordance with an advantageous further development of the invention, the transmissions are preferably constructed as geared neutral transmissions (finite drive rotational speeds with standing still output are made possible) and can have one or two drive ranges.

In order to improve the degree of efficiency, a gear can be provided in the overdrive in which no power flows through the variator. This can be a direct gear; it is also possible, however, to obtain a further reduction using planetary steps or spur gear steps or belt drives, which correspond to the reduction of the variator or realize an additional gear jump.

An additional shifting element can be provided for shifting the overdrive gear, wherein the overdrive gear in two range transmissions is shifted by closing both area shifting elements at a specified variator reduction in the framework of an especially advantageous embodiment.

### BRIEF DESCRIPTION OF THE DRAWINGS

The invention will now be described, by way of example, with reference to the accompanying drawings in which:

FIGS. 1 to 9 represent spatial arrangement possibilities for components of a power-split transmission of the invention;

FIG. 10 is a schematic representation of a first preferred embodiment of a transmission in accordance with the invention;

FIG. 11 is a schematic representation of a second preferred embodiment of a transmission in accordance with the invention;

FIG. 12 is a schematic representation of a third preferred embodiment of a transmission in accordance with the invention; and

FIG. 13 is a schematic representation of a fourth preferred embodiment of a transmission in accordance with the invention.

### DETAILED DESCRIPTION OF THE INVENTION

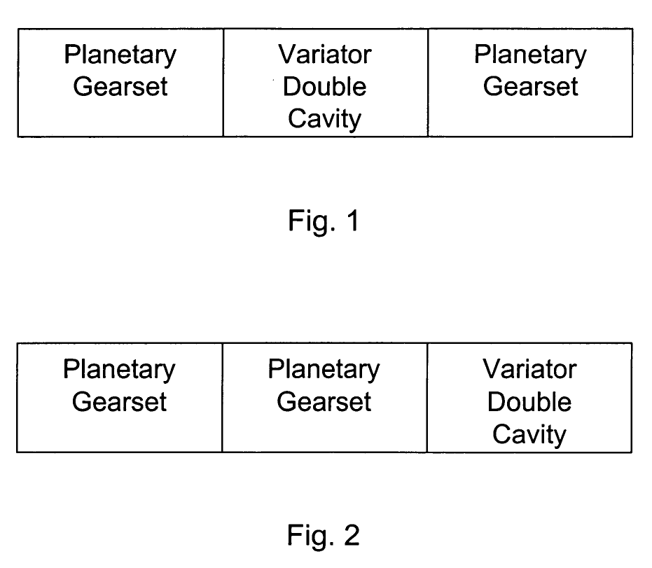

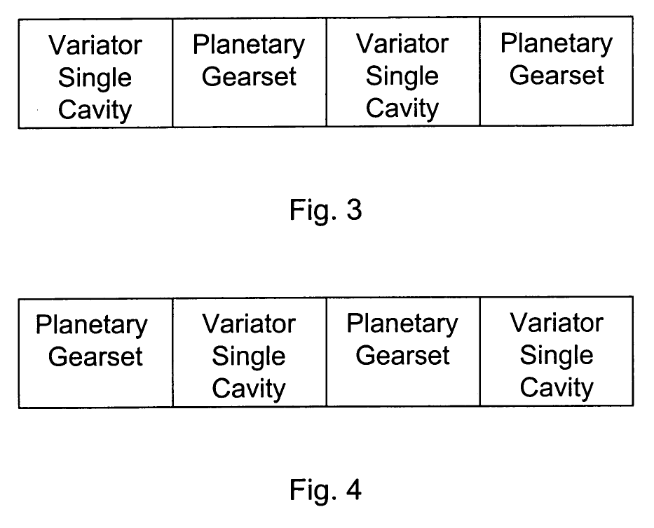

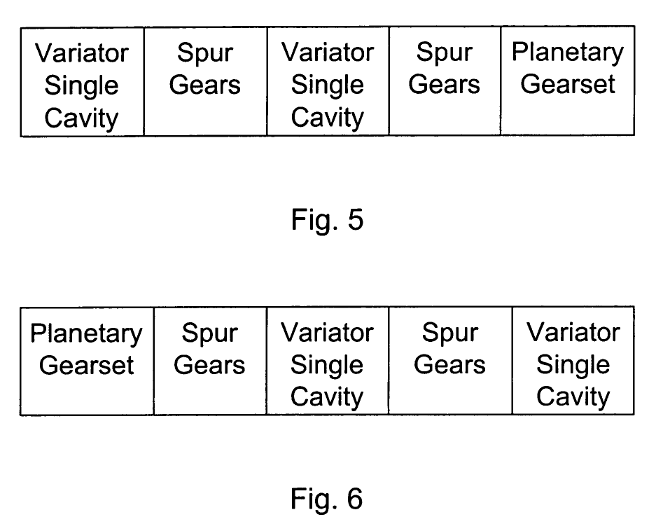

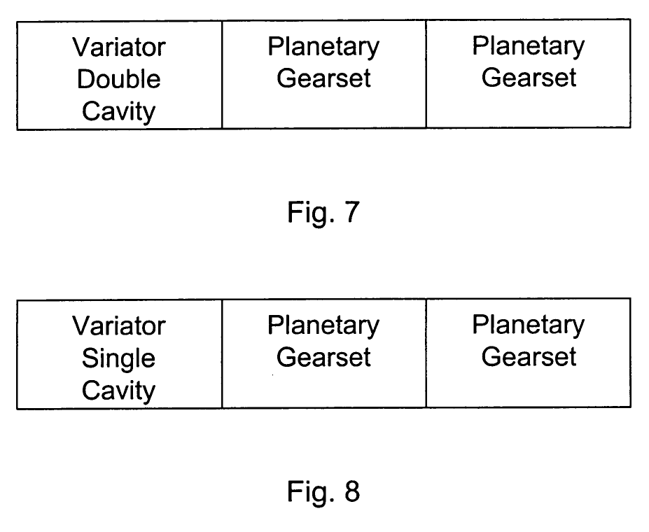

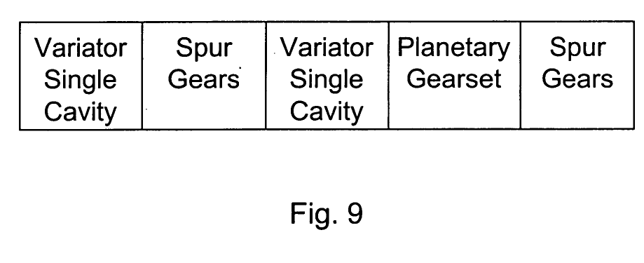

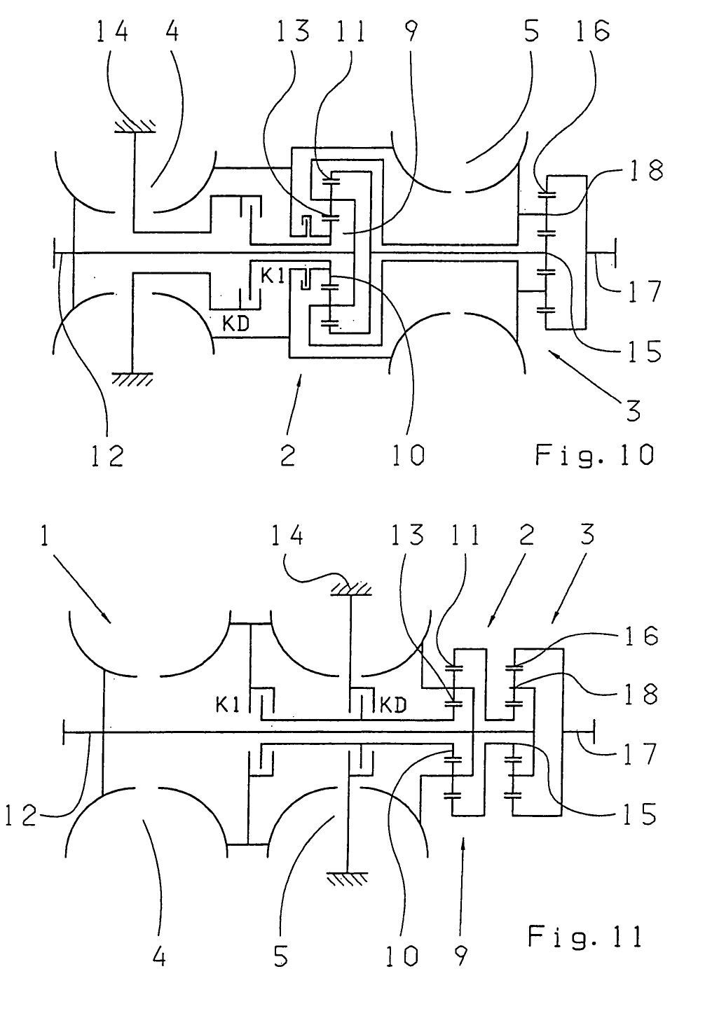

FIGS. 1 to 9 concern different arrangement possibilities that have already been explained. The concrete exemplary embodiments depicted in FIGS. 10 to 13 will be described below.

In accordance with FIG. 10, in accordance with the invention, the transmission includes a reversing friction wheel variator 1, a planetary gearset 3 serving as a summation transmission and a variator output transmission 2, which includes a planetary gearset 9. The transmission depicted is constructed as a geared neutral single range transmission. The variator output transmission 2 is arranged between the variator disk pairs 4, 5 and co-axially thereto. The variator power is hereby conducted through a sun wheel 10 and a gear ring 11 to the planetary gearset 3 when a clutch K1 is closed, which is arranged in the direction of the flux of force before the sun wheel 10 of the planetary gearset 9. An additional portion of the input is guided from a drive shaft 12 through a bar 13 of the planetary gearset 9 to the planetary gearset 3.

The sun wheel 10 of the planetary gearset 9 of the variator output transmission 2 can be connected on the drive side via the clutch K1 with the variator output and can be coupled to the housing through a shifting element or a brake KD; the bar 13 is connected on the drive side with the drive shaft 12 and on the output side with the variator and a bar 18 of the planetary gearset 3. The gear ring 11 is connected on the output side with a sun wheel 15 of the planetary gearset 3, wherein a gear ring 16 of the planetary gearset 3 is connected with an output shaft 17.

To shift the overdrive gear, the shifting element or the brake KD is closed when the clutch K1 is open. This leads to no power flowing through the variator, and the sun wheel 10 of the planetary gearset 9 is coupled into a housing 14. In this way, the power flows from the drive shaft 12 through the bar 13 and the gear ring 11 of the planetary gearset 9 to the sun wheel 15 of the planetary gearset 3, where it is then conducted via the gear ring 16 to the output shaft 17. A further portion of the output is transferred from the bar 13 of the planetary gearset 9 to the bar 18 of the planetary gearset 3.

A transmission constructed as a geared neutral single region transmission is likewise depicted in FIG. 11. It includes the reversing friction wheel variator 1 with two variator disk pairs 4, 5, the planetary gearset 3 serving as a summation transmission and the variator output transmission 2, which includes the planetary gearset 9. The variator output transmission 2 and the planetary gearset 3 are hereby arranged co-axially in relation to the variator and in the direction of the output shaft 17 behind the variator 1. When the clutch K1, which connects the variator output with the sun wheel 10 of the planetary gearset 9 of the variator output transmission, is closed, the variator power is conducted via the sun wheel 10 and the gear ring 11 to the planetary gearset 3. An additional portion of the input is conducted from the drive shaft 12 through the bar 13 and the gear ring 11 of the planetary gearset 9 to the planetary gearset 3, the gear ring 16 of which is connected with the drive shaft 17.

The sun wheel 10 of the planetary gearset 9 of the variator output transmission 2 can be connected on the drive side with the variator output via the clutch K1 and can be coupled to the housing 14 via the shifting element or the brake KD; the bar 13 is connected on the input side with the drive shaft 12 and on the output side with the variator 1. The gear ring 11 is connected on the output side with the sun wheel 15 of the planetary gearset 3, wherein the gear ring 16 of the planetary gearset 3 is connected with the output shaft 17 and the bar 18 with the drive shaft 12.

To engage the overdrive gear, the shift element or the brake KD is closed as with the exemplary embodiment from FIG. 10 when the clutch K1 is open in accordance with the invention. This leads to no power flowing through the variator and the sun wheel 10 of the planetary gearset 9 being coupled to the housing 14. In this way, the power flows from the drive shaft 12, on the one hand, through the bar 13 and the gear ring 11 of the planetary gearset 9 to the sun wheel 15 of the planetary gearset 3 and, on the other hand, to the bar 18 of the planetary gearset 3 where it is then conducted, via the gear ring 16, to the output shaft 17.

The transmission depicted in FIG. 12 includes the single-direction friction wheel variator 1 behind which the variator output transmission 2, including the planetary gearset 9 and the planetary gearset 3, which serves as a summation transmission, are arranged co-axially one behind the other in the direction of the flux of force.

The transmission is constructed as a power-split two-region transmission. Here the sun wheel 10 of the planetary gearset 9 of the variator output transmission 2 is connected on the drive side with the variator output, and the gear ring 11 is connected on the output side with the sun wheel 15 of the planetary gearset 3. Furthermore, the bar 13 of the planetary gearset 9 is coupled to the housing 14. The bar 18 of the planetary gearset 3 can be coupled to the housing, via a brake KR, and on the drive side via a clutch K2 with the drive shaft 12, whereby the gear ring 16 is connected to the drive shaft 17. Furthermore, the gear ring 16 can be connected with the drive shaft 12, via the clutch K1 and the clutch K2; the bar 18 can moreover be connected with the gear ring 16 via the clutch K1.

In the first range (LOW), the clutch K1 is closed and the power flows only through the variator 1, the planetary gearset 9 and the planetary gearset 3, which is circulating in block operation. In the second range (HIGH), a power-split is provided. Here the clutch K2 is closed so that the power is transmitted from the drive shaft 12 to the bar 18 of the planetary gearset 3 and from the variator 1 through the planetary gearset 9 to the sun wheel 15 of the planetary gearset 3. The overall power is transmitted through the gear ring 16 to the output shaft 17. The shifting element KR is closed to realize the reverse gear.

In accordance with the invention, advantageously no additional shifting element is necessary to engage the direct gear or the overdrive gear; the overdrive gear is engaged by closing the clutches K1 and K2, so that the planetary gearset circulates in block operation driven by the drive shaft 12.

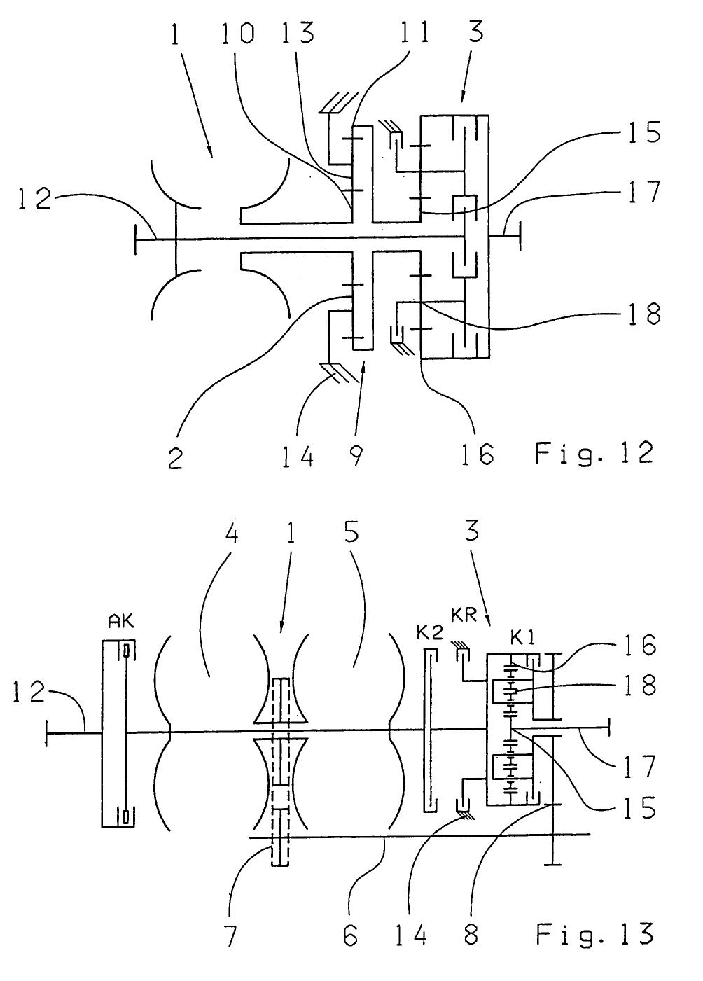

The transmission depicted in FIG. 13 includes a reversing friction wheel variator 1 with two variator disk pairs 4, 5. Moreover, a countershaft 6 is provided which is arranged axially parallel in relation to the variator 1, through which the power of the variator 1 is conducted to the output of the transmission using a belt or sprocket gear drive 7 arranged between the variator disks 4, 5 and a spur gear step 8. In addition, a planetary gearset 3, serving as a summation transmission, is provided, which is arranged co-axially in relation to the variator 1.

Here the sun wheel 15 of the planetary gearset 3 is connected with the output shaft 17. The bar 18 is connected on the drive side with the output of the variator 1, via the spur gear step 8, the shaft 6 and the belt and sprocket wheel drive 7. As is apparent from the Figure, the gear ring 16 can be coupled to the housing 14 via a brake KR, and on the drive side, the gear ring 16 can be connected with the spur gear step 8 via a clutch K1. In accordance with the invention, an additional clutch K2 is arranged between the variator 1 and the planetary gearset 3, which detachably connects the gear ring 16 with the drive shaft 12.

In the first range (LOW), the clutch K1 is closed and the power flows only through the variator 1, the belt and sprocket gear drive 7, the countershaft 6 and the spur gear stage 8 to the planetary gearset 3, which is circulating in block operation.

A power-split is provided in the second range (HIGH); here the clutch K2 is closed so that the power is transmitted on the one hand from the drive shaft 12 to the gear ring 16 of the planetary gearset 3, and on the other hand from the variator 1 through the belt and sprocket gear drive 7, the countershaft 6 and the spur gear step 8 to the bar 18 of the planetary gearset 3. The overall power is transmitted through the gear ring 16 to the drive shaft 17. The shifting element KR is closed to realize the reverse gear.

In accordance with the invention, no additional shifting element is necessary to engage the direct gear or the overdrive gear. The overdrive gear is engaged by closing the clutches K1 and K2 so that the planetary gearset circulates in block operation, driven by the drive shaft 12. A start up clutch AK is also represented in FIG. 13 for the sake of completeness.

Obviously any constructional development, especially any spatial arrangement of the planetary gearsets and the shifting elements, inherently as well as in relation to one another and to the extent that it is technically appropriate also falls under the scope of protection of the present claims without the function of the transmission, even if these constructions are not explicitly represented in the Figures or in the description.

### REFERENCE NUMERALS

1 variator
2 variator output transmission
3 planetary gearset
4 variator disk pair
5 variator disk pair
6 countershaft
7 belt or sprocket gear drive
8 spur gear step
9 planetary gearset
10 sun wheel
11 gear ring
12 drive shaft
13 bar
14 housing
15 sun wheel
16 gear ring
17 output shaft
18 bar
K1 clutch
K2 clutch
KR brake
KD clutch
AK start up clutch

1-17. (canceled)

18. A power-split transmission comprising:
a variator (1) being constructed as one of a toroid variator, a friction wheel variator, a band variator, a chain variator, a tapered ring transmission and a continuous hydrostatic transmission;
a variator output transmission (2) including a first planetary gearset (9); and
an additional planetary gearset (3) which connected in a direction of a flux of force in front of the variator, serves as a distribution transmission and connected in the direction of the flux of force behind the variator, serves as a summation transmission for the power-splits,
the variator output transmission (2), the variator (1) and the additional planetary gearset (3) are arranged coaxially, and a spatial arrangement of the variator output transmission (2), the variator (1) and the planetary gearset (3) in an output direction is indicated by one of a following schemata:
the variator (1)—the variator output transmission (2)—the additional planetary gearset (3);
the variator (1)—the additional planetary gearset (3)—the variator output transmission (2);
the additional planetary gearset (3)—the variator (1)—the variator output transmission (2);
the additional planetary gearset (3)—the variator output transmission (2)—the variator (1);
the variator output transmission (2)—the additional planetary gearset (3)—the variator (1); and
the variator output transmission (2)—the variator (1)—the additional planetary gearset (3).

19. The power-split transmission according to claim 18, wherein the variator (1) is as a reversing toroid variator having a first torus disk pair (4), a second torus disk pair (5), and the spatial arrangement of the variator output transmission (2), the first torus disk pair (4), the second torus disk pair (5) and the additional planetary gearset (3) in the output direction is indicated by one of the following schemata:
the first disk pair (4)—the variator output transmission (2)—the second disk pair (5)—the additional planetary gearset (3);
the first disk pair (4)—the additional planetary gearset (3)—the second disk pair (5) —the variator output transmission (2);
the variator output transmission (2)—the first disk pair (4)—the additional planetary gearset (3)—the second disk pair (5); and
the additional planetary gearset (3)—the first disk pair (4)—the variator output transmission (2)—the second disk pair (5).

20. A power-split transmission comprising;
a variator (1) constructed as one of a toroid variator, a friction wheel variator, a band variator, a chain variator, a tapered ring transmission and a continuous hydrostatic transmission,
a planetary gearset (3), connected in a direction of a flux of force before the variator, serves as a distribution transmission, and, connected in a direction of a flux of force behind the variator, serves as a summation transmission for power-splits, in which a countershaft (6) arranged axially parallel and axially staggered in relation to the variator is provided, through which power of the variator is conducted to output of the transmission using one or more of a spur gear step and at least one of a first spur gear step (7) and a second spur gear step (8),
a spatial arrangement of the one of spur gear steps, the belt, the first spur gear step (7) and the second spur gear step (8), the variator (1) and the additional planetary gearset (3) in the output direction is indicated by one of the following schemata:
the variator (1)—the first spur gear step (7)—the second spur gear step (8)—the additional planetary gearset (3);
the variator (1)—the first spur gear step (7)—the additional planetary gearset (3)—the second spur gear step (8); and
the additional planetary gearset (3)—the variator (1)—the first spur gear step (7)—the second spur gear step (8).

21. The power-split transmission according to claim 20, wherein the variator (1) is a reversing toroid variator having a first torus disk pair (4) and a second disk pair (5), the spatial arrangement of the one of the spur gear steps, the belt, and the first and second spur gear steps (7, 8), the variator (1) and the additional planetary gearset (3) in the output direction being indicated by one of the following schemata:
the first disk pair (4)—the first spur gear step (7)—the second disk pair (5)—the third spur gear step (8)—the additional planetary gearset (3);
the additional planetary gearset (3)—the first spur gear step (7)—the second disk pair (4)—the second spur gear step (8)—the second disk pair (5); and
the first disk pair (4)—the first spur gear step (7)—the second disk pair (5)—the additional planetary gearset (3)—the second spur gear step (8).

22. The power-split transmission according to claim 18, wherein the power-split transmission is a geared neutral transmission.

23. The power-split transmission according to claim 18, wherein the power-split transmission is one of a single region and a two region transmission.

24. The power-split transmission according to claim 18, wherein the first and second planetary gearsets (3, 9) are one of a plus and a minus planetary gearsets.

25. The power-split transmission according to claim 24, wherein a gear is provided in overdrive, in which no power flows through the variator (1, 4, 5).

26. The power-split transmission according to claim 25, wherein the gear is one of a direct gear and another gear such that a further reduction is attained using one of planetary stages, spur gear steps, a belt and first and second spur gear steps (7, 8).

27. The power-split transmission according to claim 25, wherein an additional shifting element (KD) is provided for engaging the gear in which no power flows through the variator (1, 4, 5).

28. The power-split transmission according to claim 25, wherein shifting elements (K1, K2) engage for engaging individual ranges to engaging a gear in which no power flows over the variator (1, 4, 5) in two range transmissions.

29. The power-split transmission according to claim 27, including a friction wheel variator (1) with two variator disk pairs (4, 5), wherein the variator output transmission (2), includes one planetary gearset (9), arranged between the two variator disk pairs (4, 5) and coaxially thereto, wherein the additional planetary gearset (3), serving as a summation transmission, is arranged coaxially to the planetary gearset (9), such that a sun wheel (10) of the planetary gearset (9) of the variator output transmission (2) can be connected with the variator output on a drive side via a clutch (K1) and can be coupled to a housing (14) via a brake (KD), a bar (13) of the planetary gearset (9) is connected on the drive side with a drive shaft (12) and on the output side with the variator (1) and another bar (18) of the additional planetary gearset (3), and a gear ring (11) of the planetary gearset (9) is connected on an output side with a sun wheel (15) of the additional planetary gearset (3), and a gear ring (16) of the additional planetary gearset (3) is connected with an output shaft (17).

30. The power split transmission according to claim 27, including a friction wheel variator (1) with two variator disk pairs (4, 5), the variator output transmission (2) and the additional planetary gearset (3) are arranged coaxially in relation to the variator (1) and in the direction of an output shaft (17) behind the variator (1), a sun wheel (10) of the planetary gearset (9) of the variator output transmission (2) is connected with the variator output on the drive side via a clutch (K1) and can be coupled to a housing (14) via a brake (KD), a bar (13) of the planetary gearset (9) is connected with a drive shaft (12) on the drive side and on the output side with the variator (1), and a gear ring (11) of the planetary gearset (9) is connected on the output side to a sun wheel (15) of the additional planetary gearset (3), a gear ring (16) of the additional planetary gearset (3) is connected with the output shaft (17) and a bar (18) of the additional planetary gearset (3) is connected with the drive shaft (12).

31. The power-split transmission according to claim 29, wherein shifting takes place by engaging the clutch (K1) into a driving region and an overdrive gear is engaged by engaging the brake (KD).

32. The power-split transmission according to claim 28, wherein power-split transmission further comprises a single-direction friction wheel variator (1), behind which the variator output transmission (2) and the additional planetary gearset (3), which serves as a summation transmission, are arranged coaxially in a direction of an output shaft (17), a sun wheel (10) of the planetary gearset (9) of the variator output transmission (2) is connected on a drive side with a variator output, a gear ring (11) of the planetary gearset (9) is connected on an output side with a sun wheel (15) of the additional planetary gearset (3), a bar (13) of the planetary gearset (9) is coupled to a housing (14), a bar (18) of the additional planetary gearset (3) is coupled to the housing (14) via a brake (KR) and can be connected on the drive side with a drive shaft (12) via a second clutch (K2), a gear ring (16) of the additional planetary gearset (3) is connected with the output shaft (17) and is connected with the drive shaft (12) via a first clutch (K1) and the second clutch (K2), and the bar (18) of the additional planetary gearset (3) is connected with the gear ring (16) via the first clutch (K1).

33. The power-split transmission according to claim 28, wherein the variator is a friction wheel variator (1) with two variator disk pairs (4, 5), and a countershaft (6) arranged axially parallel in relation to the variator (1) is provided, via which power of the variator (1) is conducted to output of the transmission using one of a belt or sprocket wheel drive (7), arranged between the two variator disks (4, 5), and a spur gear step (8), the additional planetary gearset (3) serving as a summation transmission is arranged coaxially in relation to the variator (1), a sun wheel (15) of the additional planetary gearset (3) is connected with an output shaft (17), and a bar (18) of the additional planetary gearset (3) is connected on a drive side with an output of the variator (1) via the belt drive (7), the countershaft (6) and the belt drive (7), and a gear ring (16) of the additional planetary gearset (3) are coupled to a housing (14) via a brake (KR), wherein the bar (18) can be connected on the drive side with the spur gear step (8) via a first clutch (K1), and a second clutch (K2) is arranged between the variator (1) and the additional planetary gearset (3) which connects the gear ring (16) with a drive shaft (12).

34. The power-split transmission according to claim 32, wherein a first driving region results by engaging the first clutch (K1), a second driving region with power-split by engaging the second clutch (K2), a reverse gear by engaging the brake (KR) and the overdrive gear by engaging the first clutch (K1) and the second clutch (K2).
